(19) United States
(12) Patent Application Publication
(10) Pub. No.: US 2004/0098565 A1
(43) Pub. Date: May 20, 2004

(54) Instruction queue for an instruction pipeline

(76) Inventors: Joseph Rohlman, Portland, OR (US); Anil Sabbavarapu, Hillsboro, OR (US); Robert F. Krick, Fort Collins, CO (US)

Correspondence Address: John C. Altmiller, KENYON & KENYON, Suite 700, 1500 K Street, N.W., Washington, DC, 20005, US

(21) Appl. No.: 10/601,172

(22) Filed: Jun. 19, 2003

Related U.S. Application Data
(63) Continuation of application No. 09/223,219, filed on Dec. 30, 1998, now abandoned.

(51) Int. Cl. G06F 9/30

(52) U.S. Cl. 712/214; 712/219

(57) ABSTRACT

An instruction pipeline in a microprocessor, comprising a plurality of pipeline units with each of the pipeline units processing instructions. At least one of the plurality of pipeline units receives the instructions from another of the pipeline units, stores the instructions and reissues at least one of the instructions after a stall occurs in the instruction pipeline.

### FIELD OF THE INVENTION

The present invention is directed to improvements to an instruction pipeline in a microprocessor.

### BACKGROUND INFORMATION

Modern microprocessors include instruction pipelines in order to increase program execution speeds. Instruction pipelines typically include a number of units, each unit operating in cooperation with other units in the pipeline. One exemplary pipeline, found in, for example, Intel's Pentium® Pro microprocessor, includes an instruction fetch unit (IFU), an instruction decode unit (ID), an allocation unit (ALLOC), an instruction execution unit (EX) and a write back unit (WB). The IFU fetches program instructions, the ID translates the instructions into micro-instructions (micro-ops), the ALLOC assigns a sequence number to each micro-op, the EX executes the micro-ops, and the WB retires instructions.

As the micro-ops are fed through the pipeline, one of the units may perform its function faster than the unit that is next in the pipeline, causing a bottleneck or a stall in the pipeline. A control signal can be fed back through the pipeline to the unit causing the stall indicating that a stall has occurred in the pipeline ahead of that unit so the micro-ops can be redirected to avoid the stall in the pipeline. The stall situation is exasperated in advanced microprocessors because of the advanced capability of some of the units in the pipeline. For example, if the pipeline includes a trace cache unit, stalls become more likely because a trace cache unit is capable of outputting the micro-ops at high speeds relative to the other units in the pipeline. A trace cache builds and stores instruction “trace segments” in cache memory. The structure and operation of a trace cache is described in further detail in U.S. Pat. No. 5,381,533 to Pelag et al.

In an ideal situation, the stall signal would be sent directly to the unit causing the stall so the micro-ops can be redirected to avoid the stall, as described above. However, these advanced units, for example the trace cache, is a large memory array that takes a relatively long time to read. In this situation, if the unit received the stall signal directly, the unit may have already output a series of micro-ops before it recognized the stall signal. These micro-ops will be invalidated by the next unit in the pipeline because it is not capable of receiving them at the present time. Additionally, the instruction pipeline may be several instructions deep between pipeline units. For example, a first pipeline unit may have output five micro-ops to a second pipeline unit. However, the second pipeline unit may have only received the first of the five micro-ops because the depth of the instruction pipeline. If a stall were to occur at this point, the second through fifth micro-ops could not be received by the second pipeline unit and these micro-ops would be invalidated. There is no manner of recovering these invalid micro-ops, thus leading to a program stall because critical micro-ops are not executed by the microprocessor.

### SUMMARY OF THE INVENTION

An instruction pipeline in a microprocessor, comprising a plurality of pipeline units with each of the pipeline units processing instructions. One of the plurality of pipeline units receives the instructions from another of the pipeline units, stores the instructions and reissues at least one of the instructions after a stall occurs in the instruction pipeline.

### BRIEF DESCRIPTION OF THE DRAWINGS

FIG. 1 shows a block diagram of an exemplary instruction pipeline of a microprocessor according to the present invention.

FIG. 2 shows a block diagram of an exemplary portion of an instruction pipeline of a microprocessor according to the present invention.

FIG. 3a shows an exemplary process for controlling a write pointer according to the present invention.

FIG. 3b shows an exemplary process for controlling a read pointer according to the present invention.

FIG. 3c shows an exemplary process for controlling a stall pointer according to the present invention.

FIG. 3d shows an exemplary process for controlling whether the instruction queue according to the present invention operates in read mode or bypass mode.

FIG. 3e shows an alternate exemplary process for controlling whether the instruction queue according to the present invention operates in read mode or bypass mode.

FIG. 4 shows a block diagram of an exemplary portion of an instruction pipeline of a microprocessor operating in a multi-thread mode according to the present invention.

FIG. 5 shows an exemplary process for controlling thread selection according to the present invention.

### DETAILED DESCRIPTION

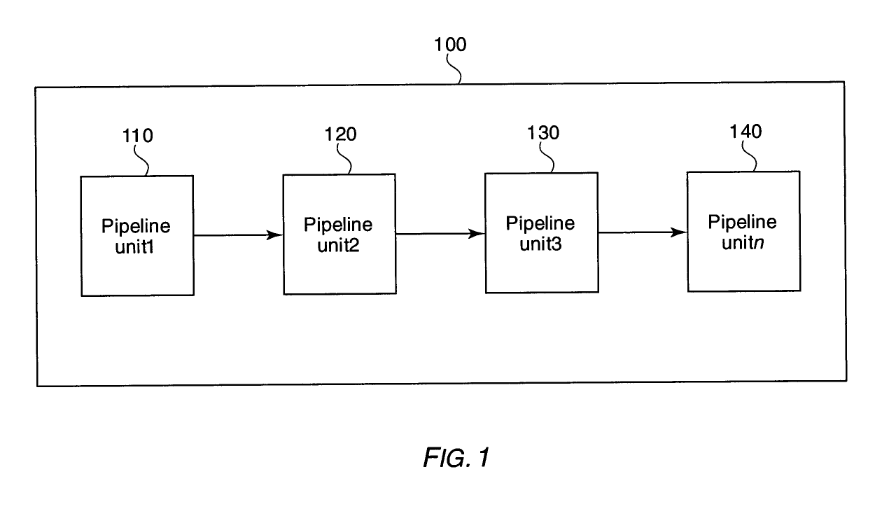

Overall System Architecture: Referring now to the drawings, and initially to FIG. 1, there is illustrated the overall system architecture of the present invention. As shown, instruction pipeline 100 includes a plurality of pipeline units, i.e., pipeline unit1 110, pipeline unit2 120, pipeline unit3 130 and pipeline unitn 140. Although four pipeline units are illustrated, the instruction pipeline 100 may include more or less units. Additionally, although the pipeline units of pipeline 100 are illustrated as coupled in series, alternative connections are possible. For example, pipeline unit3 130 may be connected in parallel with another unit, such as, for example, pipeline unit2 120.

Pipeline unit1 110 may be, for example, an instruction source for pipeline 100. That is, pipeline unit1 110 may fetch instructions from, for example, main memory, cache memory, etc., and provide the fetched instructions to the instruction pipeline 100 for processing. In the embodiment illustrated, each pipeline unit processes instructions received from an upstream pipeline unit, and then passes the processed instructions to the next downstream unit. For example, pipeline unit2 120 may receive instructions from pipeline unit1 110, and may decode the received instructions. The decoded instructions may then be passed to pipeline unit3 130. (Of course, in some processors, instructions do not require decoding. In such a processor, the instruction pipeline 100 would not need a decode unit.)

Pipeline unit3 130 may be an instruction queue. The instruction queue can operate in at least two modes, a bypass mode and a read mode. The function of an instruction queue during bypass mode is to pass instructions from the upstream pipeline units to downstream pipeline units and store a copy of these passed instructions in a memory array of the instruction queue.

Instruction pipeline 100 also includes an instruction execution unit. For example, pipeline unitn 140 may receive instructions from an upstream pipeline unit, and execute the instructions, either in the order received, or out-of-order sequence (depending on, for example, the particular architecture of the processor.) Those skilled in the art will understand that the present invention can be applied to any level of the program instruction that can be processed by an instruction pipeline, e.g. micro-ops, thus, when using the term instruction throughout this specification it should be understood that it is not limited to any particular type of instruction.

As described above, some pipeline units may issue instructions at a rate faster than downstream pipeline units may be capable of accepting instructions. For example, pipeline unit2 120 may issue instructions faster than pipeline unitn 140 can process these issued instructions. When the storage capacity of pipeline unitn 140 is full, a stall occurs in the pipeline and no more instructions can be accepted by pipeline unitn 140. A lack of resources is not the only circumstance that will generate a stall signal, but it is a common circumstance. Any reference to a stall in this description includes all of the circumstances that may cause a stall.

When a stall occurs, pipeline unitn 140 may generate a stall signal to alert the upstream pipeline units that it is no longer accepting instructions. However, the upstream pipeline units, for example, pipeline unit2 120, may have issued instructions that are already in the pipeline. These already issued instructions cannot be accepted by pipeline unitn 140 and are lost. As described above, pipeline unit3 130 may be an instruction queue. Prior to the stall, pipeline unit3 130 would be operating in bypass mode, passing the instructions from pipeline unit2 120 to pipeline unitn 140 and storing these instructions as they are passed. After the stall occurs, pipeline unit3 130, acting as an instruction queue, shifts from bypass mode to read mode. In read mode, the instructions stored in pipeline unit3 130 are issued to pipeline unitn 140. As described above, when pipeline unit3 130 is operating in bypass mode, it is storing a copy of all of the instructions issued by pipeline unit2 120, including those instructions that are lost because of the stall in the pipeline. These lost instructions must be executed in order for the program to run correctly, and thus must be reissued to pipeline unit 140 when the stall has cleared. This is the function of pipeline unit3 130, acting as an instruction queue and operating in read mode. Since it has previously stored a copy of these lost instructions, pipeline unit3 130 can reissue these instructions directly to pipeline unitn 140 without the need for the upstream pipeline units, for example, pipeline unit2 120 to reissue these lost instructions. One skilled in the art would understand that an instruction queue can be used at various locations in the pipeline to carry out these functions of the present invention.

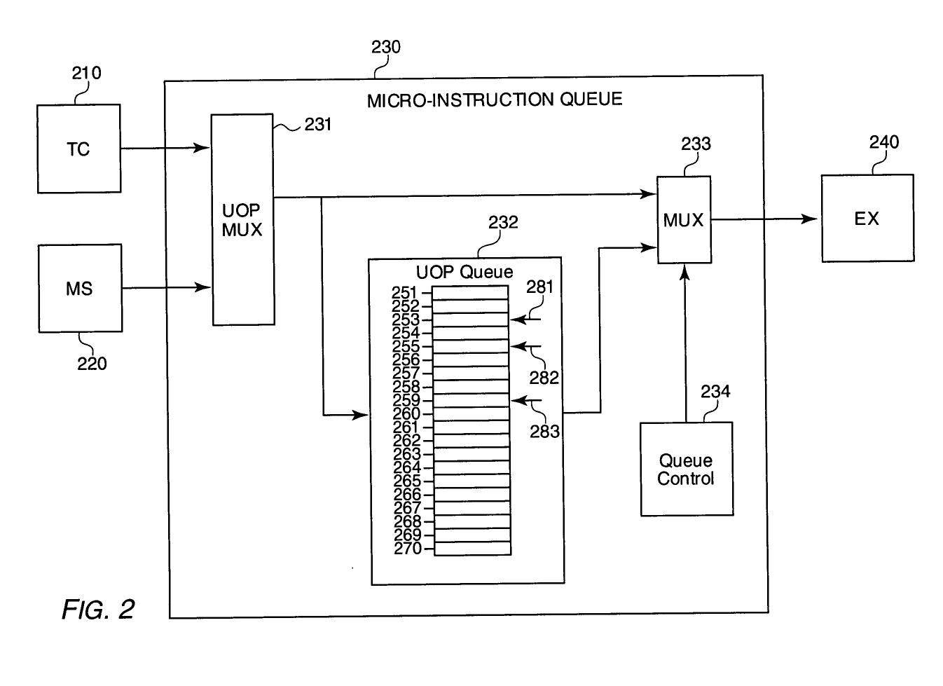

Overview Of An Additional Exemplary Embodiment: FIG. 2 illustrates an additional embodiment of the present invention. This embodiment illustrates an exemplary portion of a microprocessor pipeline. As shown, the exemplary portion of the pipeline includes a trace cache (TC) 210, a micro-instruction sequencer (MS) 220, a micro-instruction queue 230, and an execution unit (EX) 240. It would be understood by one skilled in the art that the micro-instruction queue of the present invention can be implemented at any point in the pipeline and the position of the micro-instruction queue 230 in FIG. 2 is only exemplary and also the use of two units issuing micro-ops, the trace cache 210 and the micro-instruction sequencer 220 is only exemplary, a single unit or multiple units may issue the micro-ops. It would also be understood by one skilled in the art that in the following description the exemplary processor uses micro-ops to execute a program, but the present invention is not limited to such processors.

The micro-instruction queue 230 includes an input multiplexer (UOP MUX) 231, a micro-op queue (UOP QUEUE) 232, an output multiplexer (MUX) 233, and a queue control 234. It should be understood that the input multiplexer 231, the micro-op queue 232, the output multiplexer 233, and the queue control 234 in micro-instruction queue 230 are only exemplary, and are used for the purpose of describing the functions carried out by the micro-instruction queue 230 of the present invention. One skilled in the art would understand that there are various arrangements of the micro-instruction queue 230 of the present invention to carry out these same functions.

In the exemplary portion of the pipeline shown in FIG. 2, the micro-ops can be issued from either the trace cache 210 or the micro-instruction sequencer 220. The input micro-op multiplexer 231 selects micro-ops from the trace cache 210 or micro-instruction sequencer 220 based on a control logic from the micro-instruction sequencer 220. Initially, the micro-instruction queue 230 operates in bypass mode. During the bypass mode, the micro-instruction queue 230 passes the micro-ops from the trace cache 210 or the micro-instruction sequencer 220 to the execution unit 240 and stores a copy of these passed micro-ops in a memory array of the micro-op queue 232.

Both the trace cache 210 and the micro-instruction sequencer 220 may issue micro-ops at a rate faster than the execution unit 240 may be capable of accepting and processing micro-ops. The execution unit 240 monitors its resources, and when it has reached its maximum capacity, the execution unit 240 sends a stall signal to the queue control 234 of micro-instruction queue 230, indicating that a stall has occurred and no more micro-ops can be accepted by the execution unit 240. Operation of the queue control 234 will be described in greater detail below.

Although a stall signal was generated, the trace cache 210 and the micro-instruction sequencer 220 may have issued micro-ops that are still in the pipeline. These micro-ops cannot be accepted by the execution unit 240 and are lost. At this point, the micro-instruction queue 230 shifts from bypass mode into read mode. In read mode the micro-ops stored in the micro-instruction queue 230 are reissued to the execution unit 240. These lost micro-ops must be executed in order for the program to run correctly, and thus must be reissued to the execution unit 240 when the stall has cleared. Since the micro-instruction queue 230 has previously stored a copy of these lost micro-ops, the micro-instruction queue 230 can reissue these micro-ops directly to the execution unit 240 without the need for the trace cache 210 or the micro-instruction sequencer 220 to reissue these micro-ops.

In accordance with this exemplary embodiment, micro-op queue 232 is a memory array containing a series of memory locations 251-270. The twenty memory locations shown in FIG. 2 are only exemplary; any number of memory locations may be employed in the micro-op queue 232. The micro-op queue 232 also includes a stall pointer 281, a read pointer 282 and a write pointer 283. The write pointer 283 indicates the memory location to which the current micro-op issued by the trace cache 210 or the micro-instruction sequencer 220 should be written. For example, in FIG. 2, after the current micro-op is written to memory location 259, write pointer 283 is advanced to the next memory location 260 so the next micro-op issued by the trace cache 210 or the micro-instruction sequencer 220 can be stored. In the exemplary embodiment, this operation of writing and storing the micro-ops is performed both when the micro-instruction queue 230 operates in bypass mode, and while the micro-instruction queue 230 operates in read mode.

As described above, during bypass mode, copies of the micro-ops issued by the trace cache 210 and the micro-instruction sequencer 220 to the execution unit 240 are stored in the micro-op queue 232. However, when a stall is detected and the micro-instruction queue 230 switches to read mode, the trace cache 210 and the micro-instruction sequencer 220 may continue to issue micro-ops. In the read mode, the micro-instruction queue 230 does not pass these micro-ops through to the execution unit 240. Instead, the micro-instruction queue 230 will direct these newly issued micro-ops to the micro-op queue 232 for storage. The micro-ops are sent to the execution unit 240 in the order they are issued by the trace cache 210 and the micro-instruction sequencer 220. Therefore, these newly issued micro-ops must be sent to the execution unit 240 after the earlier issued micro-ops that were invalidated due to the stall. Thus, micro-ops may be written to the micro-op queue 232 in both the bypass mode and the read mode.

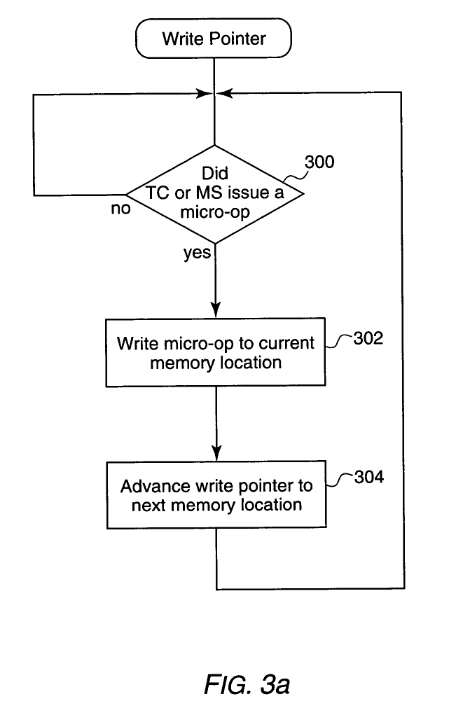

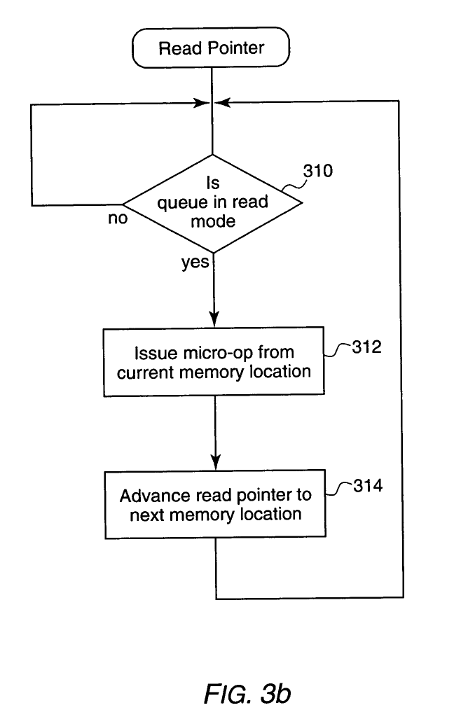

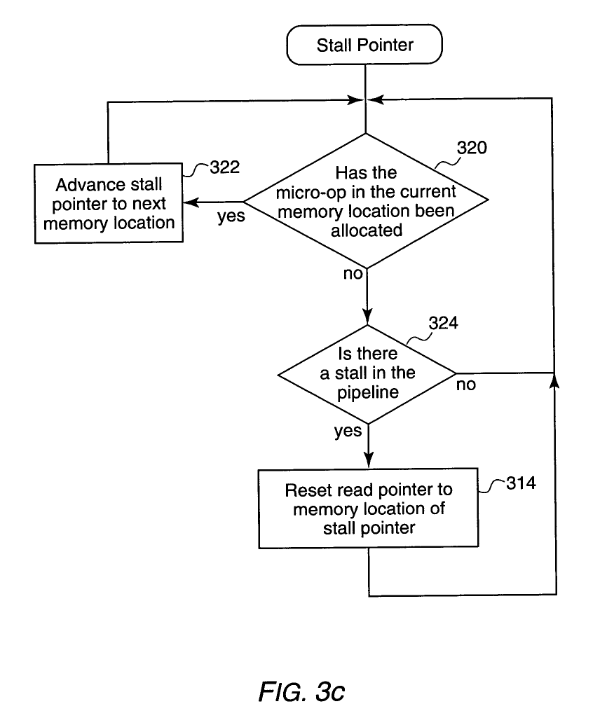

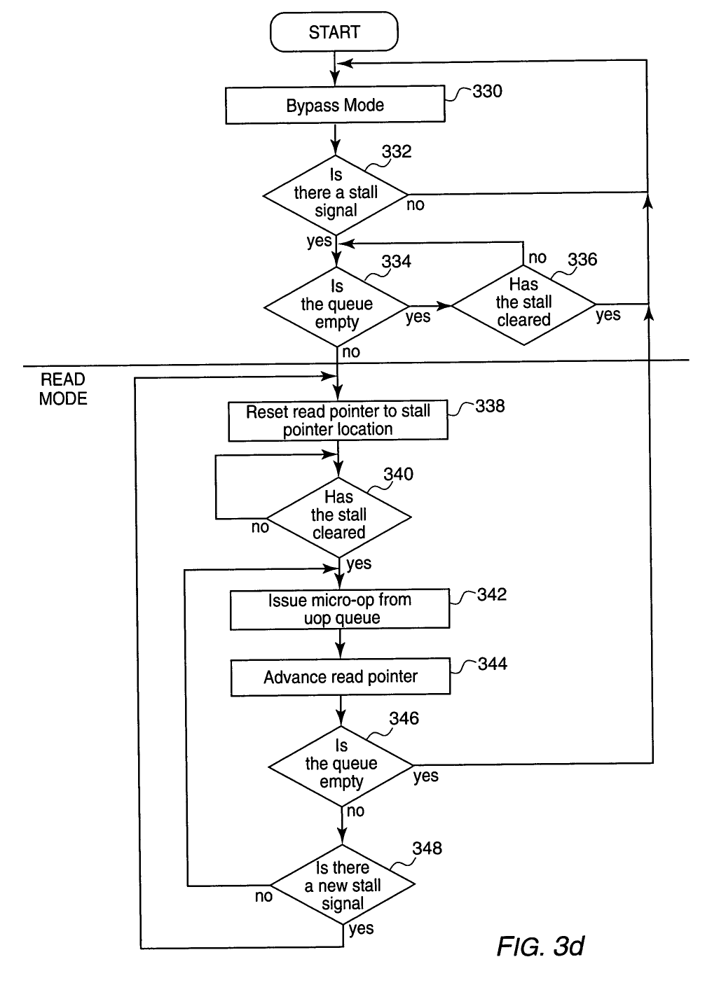

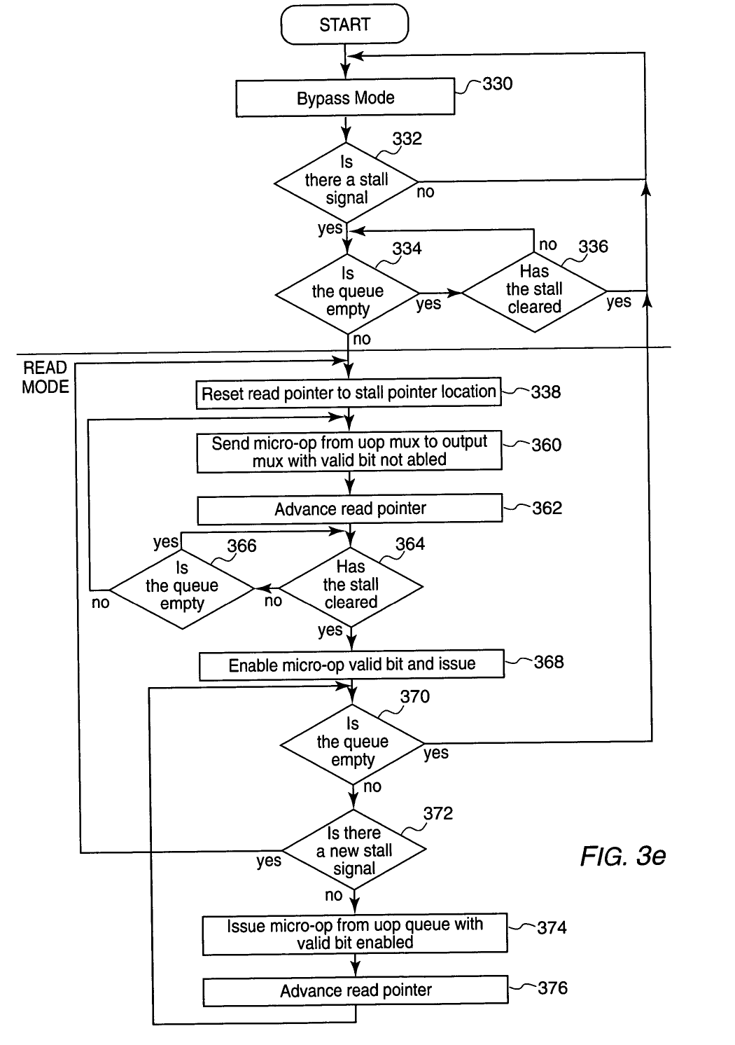

The operation of the pointers in the micro-op queue 232 may be controlled by queue control 234. FIG. 3a shows an exemplary control process for the write pointer 283. As described above, this process occurs during both the bypass and read modes of the micro-instruction queue 230. In the first step 300, the queue control determines whether the trace cache 210 or micro-instruction sequencer 220 issued a micro-op. If no micro-op has been issued, the process loops until a micro-op has been issued. Step 302 shows that when a micro-op is issued, it is copied to the current memory location in the micro-op queue 232 as indicated by write pointer 283. In the next step 304, the write pointer is advanced to the next memory location and the next micro-op issued by the trace cache 210 or micro-instruction sequencer 220 is processed.

In the exemplary embodiment, the read pointer 282 is used only during the read mode, i.e., when the micro-instruction queue 230 reissues micro-ops to the execution unit 240. The read pointer 282 indicates the memory location from which the current micro-op is to be issued. For example, the micro-op stored in memory location 255 is the current micro-op to be issued to the execution unit 240. After the micro-op from memory location 255 is issued, the read pointer 282 advances to memory location 256 and the micro-op stored in that memory location will be issued. FIG. 3b shows an exemplary control process for the read pointer 282. In step 310, it is determined whether the micro-instruction queue 230 is in read mode. If it is not in read mode, the process loops until the micro-instruction queue 230 is in read mode. When the micro-instruction queue is in read mode, as shown in step 312, the micro-op stored in the current memory location, as indicated by the read pointer 282, is issued by the micro-instruction queue 230. In the next step 314, the read pointer advances to the next memory location and the process loops to step 310 to determine if the micro-instruction queue 230 is still in the read mode.

The stall pointer 281 is used to recover the pointer location for the read pointer 282 when a stall occurs. As described above, because of latency in the pipeline, some issued micro-ops may have been lost during a stall. The micro-instruction queue 230 can monitor the pipe stages and determine which micro-ops have been lost. The stall pointer 281 indicates the memory location of the first lost micro-op. When the micro-instruction queue 230 switches to read mode, the read pointer 282 is reset to the memory location indicated by the stall pointer 281. The micro-instruction queue 230 may then begin reissuing micro-ops from this memory location. For example, in FIG. 2, stall pointer 281 indicates memory location 253 which means that the micro-op from memory location 252 has been allocated by the execution unit 240. If the micro-op from memory location 253 is allocated by the execution unit 240, the stall pointer 281 advances to memory location 254. However, if there is a stall before the micro-op stored in memory location 253 is allocated by the execution unit 240, this micro-op is lost along with any subsequently issued micro-ops. The micro-instruction queue 230 switches to read mode and starts issuing micro-ops when the stall is resolved. The read pointer 282 will be reset to memory location 253, the location of the stall pointer 281, and micro-ops are reissued beginning with this memory location.

FIG. 3c shows an exemplary control process for the stall pointer 281. In step 320, it is determined whether the micro-op in the current memory location as indicated by the stall pointer has been allocated by the execution unit 240. An allocated micro-op is one that reaches the execution unit 240 and is accepted and processed. If this micro-op has been allocated, the process proceeds to step 322 where the stall pointer 281 advances to the next memory location. The process then loops to step 320 to determine if the micro-op in the next memory location has been allocated. If in step 320, the micro-op in the current memory location has not been allocated, the process proceeds to step 324 where it is determined whether a stall has occurred in the pipeline. If there is no stall in the pipeline, the process loops to step 320 and, once again, determines whether the micro-op in the current memory location has been allocated.

In the event that a stall has occurred in the pipeline, the micro-instruction queue 230 enters read mode and the read pointer 282 is reset to the current memory location as indicated by stall pointer 281, as shown in step 326. The process then loops to step 320 and, once again, determines whether the micro-op in the current memory location has been allocated. This operation of updating the stall pointer 281 is carried out both during the bypass and read modes of the micro-instruction queue 230. When micro-ops stored in the memory locations of the micro-op queue 232 are allocated, these memory locations are cleared for newly issued micro-ops to be stored.

Control of the individual units within the micro-instruction queue 230, e.g., the input multiplexer 231, the micro-op queue 232 and the output multiplexer 233, may be accomplished using the queue control 234. For example, the queue control 234 may receive the stall signal from the execution unit 240. After receiving the stall signal, queue control 234 may signal to the other units of the micro-instruction queue 230 to begin operation in read mode. FIG. 3d shows an exemplary process for switching the micro-instruction queue 230 between read mode operation and bypass mode operation. When the processor begins executing a program, the micro-instruction queue 230 defaults to operation in the bypass mode as shown in step 330. As described above, in bypass mode, the micro-ops issued from the trace cache 210 or micro-instruction sequencer 220 as selected by the input multiplexer 231 are directed to the execution unit 240 through the output multiplexer 233. The queue control 234 controls the output multiplexer 233 allowing the micro-ops issued from the trace cache 210 or micro-instruction sequencer 220 to pass to the execution unit 240. Simultaneously, a copy of these instructions are stored in the micro-op queue 232.

During the execution of the program, it is determined whether a stall has occurred in the pipeline as shown in step 332. If no stall has occurred, the micro-instruction queue 230 continues to operate in bypass mode. If there is a stall in the pipeline, it is then determined in step 334 whether the micro-op queue 232 is empty. To determine whether the micro-op queue 232 is empty, the queue control 234 determines the position of the write pointer 283 and the stall pointer 281. If the write pointer 283 and the stall pointer 281 indicate the same memory location, the micro-op queue 232 is empty. For example, with reference to FIG. 2, if the write pointer 283 is pointing to memory location 259, this means that the last micro-op issued by the trace cache 210 or the micro-instruction sequencer 220 was written to memory location 258. If the stall pointer 281 is pointing to the same memory location 259, it also means that the micro-op stored in memory location 258 has been allocated by the execution unit 240. Therefore, all the micro-ops stored in the micro-op queue 232 have been allocated. Thus, the micro-op queue 232 is considered to be empty. If the micro-op queue 232 is empty, the process proceeds to step 336 to determine whether the stall has cleared. The execution unit 240 transmits a signal to the micro-instruction queue 230 indicating that the stall has been cleared. If the micro-op queue 232 is empty and the stall has been cleared, the process loops back to step 330 and continues processing the program in bypass mode. If it is determined in step 336 that the stall has not been cleared, the process loops back to step 334 to determine if the micro-op queue 232 has remained empty. As described above, the trace cache 210 and micro-instruction sequencer 220 may continue issuing micro-ops during the stall and these micro-ops will be written to the micro-op queue 232.

If it is determined in step 334 that the micro-op queue 232 is not empty, the micro-instruction queue 230 is switched to the read mode. The first step 338 in the read mode is to reset the read pointer 282 to the memory location indicated by the stall pointer 281. The details of this operation have been described above. The next step 340 determines whether the stall has been cleared. In the read mode, the micro-instruction queue 230 issues the micro-ops stored in the micro-op queue 232 to the execution unit 240, however these micro-ops cannot be issued until the stall has cleared. Thus, step 340 will continuously loop until the stall has been cleared. This continuous loop can be considered a stall mode of the micro-instruction queue 230, where it is waiting for the stall to clear so it can issue micro-ops. When the stall has been cleared, the process proceeds to step 342 where the micro-op from the current memory location as indicated by the read pointer 282 is issued. In step 344 the read pointer 282 advances to the next memory location of the micro-op queue 232.

The process then proceeds to step 346 to determine whether the micro-op queue 232 is empty. The method of determining whether the micro-op queue 232 is empty is the same as described above with reference to step 334. Since the micro-instruction queue 230 is operating in the read mode, the read pointer 282 indicates the same memory location as the write pointer 283 and the stall pointer 281 if the micro-op queue 232 is empty. As described in detail above, when there is a stall signal or when the micro-instruction queue 230 is issuing micro-ops in the read mode, the trace cache 210 and the micro-instruction sequencer 220 may continue issuing micro-ops that are written into the memory locations of the micro-op queue 232. The micro-instruction queue 230 remains in the read mode issuing these micro-ops until the micro-op queue 232 is empty. Thus, if it is determined in step 346 that the micro-op queue 232 is not empty, the process proceeds to step 348 to determine whether a new stall signal has occurred. If a new stall signal has occurred, the process loops back to step 338 to begin the read mode process again. If there is no new stall signal, the process loops back to step 342, so the micro-instruction queue 230 can continue issuing the micro-ops stored in the micro-op queue 232. When the micro-op queue 232 has been determined to be empty in step 346, the process loops back to step 330 where the micro-instruction queue 230 switches back to the bypass mode.

As described above, one exemplary manner of controlling the micro-instruction queue 230 is by using queue control 234. Thus, in bypass mode, the queue control 234 controls output multiplexer 233 to allow the micro-ops issued from the trace cache 210 or micro-instruction sequencer 220 to pass through micro-instruction queue 230 to the execution unit 240. In read mode, however, the queue control 234 controls output multiplexer 233 to allow the micro-ops issued from the micro-op queue 232 to be output to the execution unit 240.

FIG. 3e shows an alternate exemplary process for switching the micro-instruction queue 230 between read mode operation and bypass mode operation. This embodiment takes advantage of the fact that a micro-op may have a bit, called a valid bit, which can be enabled or disabled in the instruction pipeline. The enabling and disabling of this bit in the micro-op can be used to signal the pipeline units, e.g., the micro-instruction queue 230, to process the same micro-op in different manners, depending on the state of the valid bit, i.e. enabled or disabled. In this embodiment, steps 330-336 are the same as described in connection with FIG. 3d. Likewise, if it is determined in step 334 that the micro-instruction queue 230 is to be switched to read mode, the first step 338 of the read mode is the same as in FIG. 3d. The change in the alternate exemplary process begins with step 360, where the micro-op from the current memory location as indicated by the read pointer 282 is sent to the output multiplexer 233 of the micro-instruction queue 230. In this exemplary process, the valid bit of the micro-op is disabled. When the output multiplexer receives 233 receives a micro-op that has its valid bit disabled, that micro-op will remain at the output multiplexer 233, until the stall has been cleared. In step 362 the read pointer 282 advances to the next memory location of the micro-op queue 232. The process then proceeds to step 364 to determine whether the stall has been cleared. If the stall has not been cleared, the process proceeds to step 366 to determine whether the micro-op queue 232 is empty, which is the same step as described above with reference to step 334 in FIG. 3d. If the micro-op queue 232 is empty, the process loops back to step 364 to determine whether the stall has cleared. If the micro-op queue 232 is not empty, the process loops back to step 360 to begin the process with the micro-op in the next memory location.

If it is determined in step 364 that the stall has cleared, the valid bits of the micro-ops that have been previously sent to the output multiplexer 233 are enabled and issued to the execution unit 240 in step 368. The process described with respect to FIG. 3d, steps 340-342, did not send the micro-ops until the stall was cleared. Thus, it is possible in that process to lose pipe stages. In the process described with respect to FIG. 3e, the output multiplexer 233 acts much like a pre-fetch queue and allows the micro-ops to be issued to the execution unit 240 immediately upon clearance of the stall.

The process then proceeds to step 370 to determine whether the micro-op queue 232 is empty. If it is determined in step 370 that the micro-op queue 232 is empty, the process loops back to step 330 where the micro-instruction queue 230 switches back to bypass mode. If it is determined in step 370 that the micro-op queue 232 is not empty, the process proceeds to step 372 to determine whether a new stall signal has occurred. If a new stall signal has occurred, the process loops back to step 338 to begin the read mode process again. If there is no new stall signal, the process proceeds to step 374 where the micro-op in the current memory location of micro-op queue is issued to the execution unit 240. Step 374 differs from step 360 in that the micro-ops are issued with their valid bit enabled so that the output multiplexer 233 allows the micro-ops to be issued to the execution unit 240 without delay, because the stall has been previously cleared. In step 376, the read pointer 282 advances to the next memory location of the micro-op queue 232.

After the read pointer has been advanced, the process loops back to step 370 to determine whether the micro-op queue 232 is empty. If the micro-op queue 232 is not empty, the process proceeds to step 372 and operates as described above. If the micro-op queue 232 is determined to be empty in step 370, the process loops back to step 330 where the micro-instruction queue 230 switches back to bypass mode.

In addition to storing the micro-ops, the micro-instruction queue 230 may store instruction line data. For example, a line may consist of a series of micro-ops. For this series of micro-ops, the micro-instruction queue 230 stores associated line date. The most common type of line data is branch type information, e.g., branch history, branch predictions, although it is not the only line data that can be stored. The storage of the line data in the micro-instruction queue 230 in both the bypass mode and read mode follows the same logic as described above for the micro-ops. The micro-instruction queue 230, when storing line data, can also keep the line data in synchronization with the individual micro-ops. When an individual micro-op is issued by the micro-instruction queue 230 in read mode, the corresponding line based information can also be issued to appropriate pipeline units.

In certain situations, the trace cache 210 may issue micro-ops that are invalid. For example, if a single micro-op in a line is valid, the trace cache 210 issues the entire line of micro-ops because the trace cache 210 issues micro-ops on a line by line basis. Thus, any invalid micro-ops in this particular line are also issued by the trace cache 210. Micro-ops may become invalid because a particular portion of the program that is currently being executed does not require these micro-ops for execution. By way of a further example, if a line has six micro-ops and the first three are valid and the second three are invalid, the trace cache 210 issues the entire line of six micro-ops. Thus, the micro-op queue 232 stores all six micro-ops, and issues all six micro-ops in read mode if there is a stall. However, the micro-instruction queue 230 may also contain a control mechanism that checks if the micro-ops are valid. In the event that the micro-ops are not valid, they will not be stored in the micro-op queue 232, and the micro-instruction queue 230 is not required to issue these invalid micro-ops in the read mode. This allows the processor to improve its bandwidth during the read mode of the micro-instruction queue 230, because invalid micro-ops are eliminated. In the example above, the second three invalid micro-ops are not stored in the micro-op queue 232, thus creating a three micro-op hole. When such a hole exists, the micro-instruction queue 230 can move the first three valid micro-ops from the next line to fill this hole. Therefore, it is possible for micro-ops from multiple lines to occupy the space of a single line. In these circumstances, the micro-instruction queue 230 synchronizes the line data with the micro-ops even where micro-ops from multiple lines occupy the space of a single line. Thus, the bandwidth of the processor can be increased without the danger of losing valuable line data for the micro-ops.

The micro-instruction queue 230 can also be used to send an indirect stall signal to the trace cache 210 and the micro-instruction sequencer 220, so these units can delay in issuing micro-ops. If there was no delay, these micro-ops may be lost due to the stall. The trace cache 210 and the micro-instruction sequencer 220 may have a shared counter, or each may have an individual counter. The counter can be incremented each time a micro-op is issued by these units. Similarly, the micro-instruction queue 230 may send a signal to the counter each time one of these micro-ops are allocated by the execution unit 240, and the counter can be decremented by this signal. Thus, the number on the counter will equal the number of micro-ops stored in the micro-op queue 232, because as described above, once a micro-op is allocated it will be cleared from the micro-op queue 232. The number of memory locations in the micro-op queue 232 is fixed, for example, in FIG. 2, there are twenty memory locations 251-270. Therefore, the counter can inform the trace cache 210 and micro-instruction sequencer 220 that the micro-op queue 232 is presently full and these units should not issue any micro-ops until a micro-op is cleared from one of the memory locations. Thus, the trace cache 210 and the micro-instruction sequencer 220 will not issue new micro-ops that may be lost.

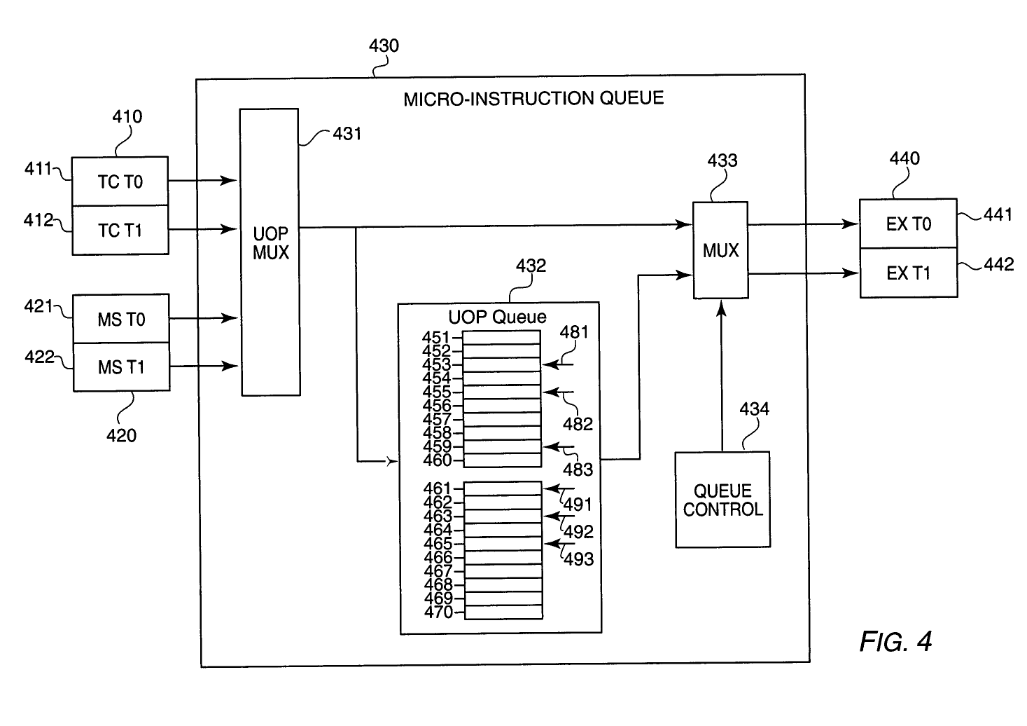

Overview Of An Additional Exemplary Embodiment: FIG. 4 illustrates an additional embodiment of the present invention. An instruction queue can also aid in the interleaving of instructions when the processor is operating in a multi-thread mode. In multi-thread mode, the processor can simultaneously process multiple threads of instructions. For example, with reference to FIG. 2, in single thread mode, three states of the micro-instruction queue 230 were described above; bypass mode, read mode and stall mode. In a multi-thread environment having two threads, for example, these states would be doubled; bypass mode for thread 0 (T0), bypass mode for thread 1 (T1), read mode for T0, read mode for T1, stall mode for T0, and stall mode for T1. The following is a description of the operation of an instruction queue during multi-thread operation of a processor having two threads. However, one skilled in the art would understand that multi-threading is not limited to two threads, and the present invention can be adapted for any number of threads.

FIG. 4 shows an exemplary portion of a microprocessor pipeline capable of operating in multi-thread mode. As shown, the exemplary portion of the pipeline includes a trace cache (TC) 410, a micro-instruction sequencer (MS) 420, a micro-instruction queue 430, and an execution unit 440. The trace cache 410 has two portions 411, 412 capable of issuing micro-ops on two different threads, thread 0 (T0) and thread 1 (T1), respectively. Similarly, the micro-instruction sequencer 420 has two portions 421, 422 capable of issuing micro-ops on T0 and T1. The micro-instruction queue 430 includes an input micro-op multiplexer (UOP MUX) 431, a micro-op queue (UOP QUEUE) 432, an output multiplexer (MUX) 433, and a queue control 434. The execution unit 440 has two portions 441, 442 capable of executing micro-ops on T0 and T1.

The micro-op queue 432 is, for example, a memory array containing a series of memory locations 451-470. The twenty memory locations in FIG. 4 are only exemplary, any number of memory locations may be employed in the micro-op queue 432. In this exemplary embodiment, the memory locations are divided among the two threads, memory locations 451-460 for T0 and memory locations 461-470 for T1. Each of the threads also contain pointers. The memory locations for T0 451-460 include stall pointer 481, read pointer 482 and write pointer 483. The memory locations for T1 461-470 include stall pointer 491, read pointer 492 and write pointer 493. The functions of all the units in FIG. 4 are similar to those described above for the corresponding units in FIG. 2. For example, the micro-op queue 432 functions similarly to micro-op queue 232 in FIG. 2, with the only difference being that micro-op queue 432 performs these functions for two threads of micro-ops and micro-op queue 232 performs the functions for one thread.

One of the advantages of operating in multi-thread mode is that it is possible to increase the bandwidth of the processor. For example, as described above with reference to FIG. 2, when a stall occurs in a processor operating in a single thread environment, it may be required to wait for the stall to clear before any additional micro-ops can be issued by the micro-instruction queue 230. When a stall occurs on one thread in a multi-thread environment, the micro-instruction queue 430 can issue micro-ops from the other thread, thus the stall on one thread may not effect the throughput of micro-ops in the processor.

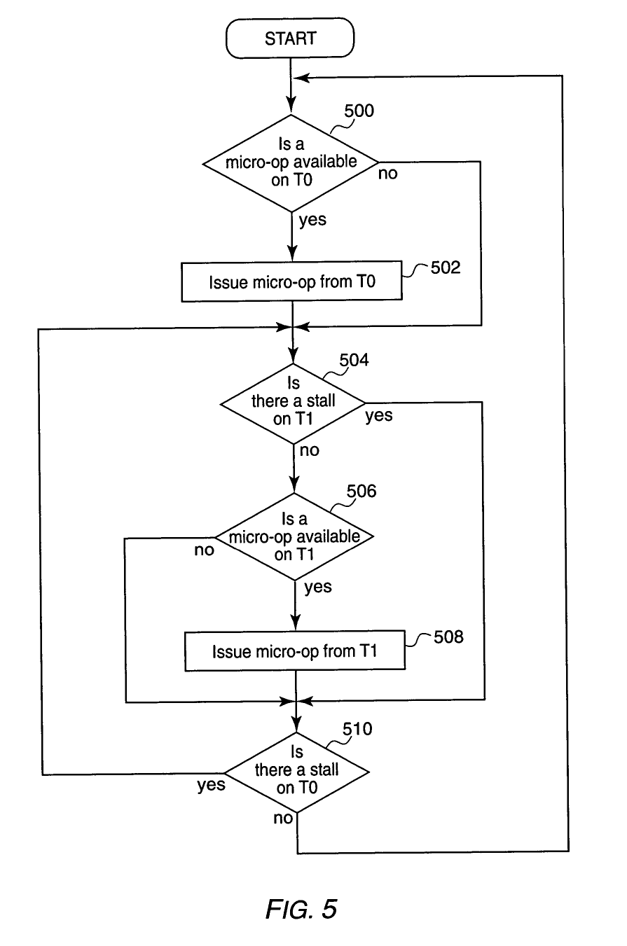

FIG. 5 shows an exemplary process for the micro-instruction queue 430 to select a thread to issue micro-ops. This process may be implemented, for example, by the queue control 434. In the first step 500, it is determined whether a micro-op is available on T0. One skilled in the art would understand that it is not necessary to begin the process using T0, it could just as easily be implemented starting with T1, or in the event that there are more than two threads, any thread can be the initial starting thread. In step 500, the micro-instruction queue 430 determines whether a micro-op is available on T0 by ascertaining if the trace cache 410 or the micro-instruction sequencer 420 has issued a micro-op on T0, or if the T0 memory locations 451-460 of micro-op queue 432 are not empty. As discussed above, the units of the pipeline function the same as described above in the single thread mode. Thus, determining whether the T0 memory locations 451-460 are empty is performed using the stall pointer 481 and the write pointer 483, in the same manner as described above in reference to FIG. 2.

If there is a micro-op available on T0, the process proceeds to step 502, where a micro-op from T0 is issued. As discussed above, the micro-instruction queue 430 performs in the same manner as micro-instruction queue 230 of FIG. 2. Therefore, the micro-instruction queue 430 can issue micro-ops in either the bypass or read mode. In bypass mode, the micro-ops from the T0 portion 411 of the trace cache 410 or the T0 portion 421 of the micro-instruction sequencer 420 are passed through the micro-instruction queue 430 to the execution unit 440. In read mode, the micro-instruction queue 430 will issue the micro-ops stored in the T0 memory locations 451-460 of the micro-op queue 432 to the execution unit 440.

After the micro-op is issued from T0 in step 502, or if there is no micro-op available on T0 in step 500, the process proceeds to step 504 to determine if T1 is stalled. If there is no stall on T1, the process proceeds to step 506 to determine whether there is a micro-op available on T1. Step 506 is identical to step 500, except the determination is made on T1 rather than T0. If there is a micro-op available on T1, in step 508 micro-instruction queue 430 issues a micro-op from T1. Step 508 is identical to step 502, except the micro-op is issued from T1 rather than T0. After the micro-op is issued from T1 in step 508, or if in step 504 there is a stall on T1, or if in step 506 there are no micro-ops available on T1, the process proceeds to step 510 to determine whether there is a stall on T0. If there is no stall on T0, the process loops back to step 500 to start over on T0. If there is a stall on T0, the process loops back to step 504 to start the process on T1.

When a stall occurs, the bandwidth of the processor is adversely effected because normally some pipe stages will be lost due to invalidated micro-ops. The micro-instruction queue 430 can also be used to limit the number of stalls when the processor is operating in multi-thread mode. As described above, when a stall occurs on one thread, the micro-instruction queue 430 can switch to another thread. However, even though this may save some pipe stages, there still may be some micro-ops that are lost on the thread having the stall condition. Thus, a decrease in the number of stalls results in fewer lost micro-ops. The micro-instruction queue 430 may be used to monitor the pipeline resources on the threads and compare these resources. The micro-instruction queue 430 may then select the thread having more available resources, decreasing the probability of a stall. For example, through a feedback loop, the micro-instruction queue 430 can monitor the resources available in the execution unit 440. For example, there may be more available space in the T0 portion 441 of execution unit 440 than in the T1 portion 442 of execution unit 440. In this case, the micro-instruction queue 430 can select T0 because there are more available resources on that thread. Thus, the number of stalls can be limited and the bandwidth of the processor can be improved.

As described above, the trace cache 410 and the micro-instruction sequencer 420 may have a counter that keeps track of the number of micro-ops stored in the micro-op queue 432. In multi-thread mode, this counter can also be useful for the trace cache 410 and the micro-instruction sequencer 420 to determine on which thread the units should issue micro-ops. A counter may be provided for each thread, and when the memory locations of one of the threads becomes full or approaches full the trace cache 410 or the micro-instruction sequencer 420 can issue micro-ops on the other thread. For example, if a counter monitoring T0 indicates that the T0 memory locations 451-460 are full, the trace cache 410 will issue micro-ops from its T1 portion 412.

Other Embodiments: While the present invention has been particularly shown and described with reference to an exemplary embodiment thereof, it will be understood by those skilled in the art that various changes in form and details may be made therein without departing from the spirit and scope of the invention.

What is claimed is:

1. An instruction pipeline in a microprocessor, comprising:
a plurality of pipeline units, each of the pipeline units processing instructions, at least one of the plurality of pipeline units receiving the instructions from another of the pipeline units, storing the instructions and reissuing at least one of the instructions after a stall occurs in the instruction pipeline.

2. The instruction pipeline of claim 1, wherein the at least one of the plurality of pipeline units reissues the at least one of the instructions in order.

3. The instruction pipeline of claim 1, wherein the at least one of the plurality of pipeline units stores only valid instructions of the instructions.

4. The instruction pipeline of claim 1, wherein the instructions are distributed in multiple threads for the plurality of pipeline units to process.

5. An instruction pipeline in a microprocessor, comprising:
at least one upstream pipeline unit issuing a first series of instructions and a second series of instructions;
at least one downstream pipeline unit allocating the first series of instructions and the second series of instructions; and
an instruction queue, wherein in a first operating mode, the instruction queue passes the first series of instructions from the at least one upstream pipeline unit to the at least one downstream pipeline unit and stores the first series of instructions, and in a second operating mode the instruction queue stores the second series of instructions and issues at least one of the first series of instructions and the second series of instructions to the at least one downstream pipeline unit.

6. The instruction pipeline of claim 5, wherein the instruction queue includes a memory array storing the first series of instructions and the second series of instructions.

7. The instruction pipeline of claim 6, wherein the at least one of the first series of instructions and the second series of instructions are issued from the memory array.

8. The instruction pipeline of claim 5, wherein the first operating mode is a default operating mode of the instruction queue.

9. The instruction pipeline of claim 5, wherein the instruction queue switches from the first operating mode to the second operating mode after receiving a stall signal from the at least one downstream pipeline unit.

10. The instruction pipeline of claim 9, wherein the at least one downstream pipeline unit includes a resource, and wherein the at least one downstream pipeline unit generates the stall signal when the resource is full.

11. The instruction pipeline of claim 5, wherein the at least one upstream pipeline unit includes a trace cache.

12. The instruction pipeline of claim 5, wherein the at least one upstream pipeline unit issues the first series of instructions in a first predetermined order, and the instruction queue in the first operating mode passes and stores the first series of instructions in the first predetermined order.

13. The instruction pipeline of claim 12, wherein the at least one upstream pipeline unit issues the second series of instructions in a second predetermined order, and the instruction queue in the second operating mode stores the second series of instructions in the second predetermined order, and issues the at least one of the first series of instructions in the first predetermined order prior to issuing the second series of instructions in the second predetermined order.

14. The instruction pipeline of claim 6, wherein the at least one upstream pipeline unit includes a counter, the counter being incremented when the at least one upstream pipeline unit issues each of the first series of instructions and each of the second series of instructions, the counter being decremented when the at least one downstream pipeline unit allocates each of the first series of instructions and each of the second series of instructions, and wherein when the counter is one of greater than and equal to a predetermined value, the at least one upstream pipeline unit delays in issuing a next one of the first series of instructions and the second series of instructions until the counter is less than the predetermined value.

15. The instruction pipeline of claim 14, wherein the predetermined value is equal to a number of memory locations in the memory array.

16. The instruction pipeline of claim 5, wherein the instruction queue includes:
a memory array for storing the first series of instructions and the second series of instructions; and
an output multiplexer for issuing the at least one of the first series of instructions and the second series of instructions in the second operating mode, the at least one of the first series of instructions and the second series of instructions being sent from the memory array to the output multiplexer when the instruction queue receives a stall signal, and wherein the output multiplexer issues the at least one of the first series of instructions and the second series of instructions when the stall signal clears.

17. An instruction pipeline in a microprocessor, comprising:
at least one upstream pipeline unit issuing each of a series of instructions on one of a plurality of instruction threads;
at least one downstream pipeline unit allocating each of the series of instructions on the one of the plurality of instruction threads which the at least one upstream pipeline issued each of the series of instructions; and
an instruction queue, wherein in a first operating mode, the instruction queue passes each of the series of instructions from the at least one upstream pipeline unit to the at least one downstream pipeline unit on the one of the plurality of instruction threads on which each of the series of instructions were issued and storing each of the series of instructions, at least one memory location being dedicated to each of the plurality of instruction threads, and in a second operating mode the instruction queue issues to the at least one downstream pipeline unit at least one of the series of instructions on the one of the plurality of instruction threads on which the at least one of the series of instructions was issued.

18. The instruction pipeline of claim 17, wherein the instruction queue in the first operating mode alternates passing the series of instructions on the one of the plurality of instruction threads on which each of the series of instructions were issued when a stall signal is not present on any of the plurality of instruction threads, and when the stall signal is present on one of the plurality of instruction threads, the instruction queue issues the series of instructions on an other one of the plurality of instruction threads.

19. The instruction pipeline of claim 17, wherein the at least one upstream pipeline unit determines the one of the plurality of instruction threads on which to issue each of the series of instructions based the availability of resources on each of the plurality of instruction threads.

20. An instruction queue in an instruction pipeline of a microprocessor, comprising:
at least one memory array; and
an output multiplexer for selecting one of a first instruction source and a second instruction source to output instructions, the second instruction source being selected after the instruction queue receives a stall signal, and wherein the second instruction source is the at least one memory array.

21. The instruction queue of claim 20, further comprising a queue control for receiving the stall signal and controlling the selection by the output multiplexer.

22. The instruction queue of claim 20, the memory array including:
a plurality of memory locations for storing the instructions;
a write pointer indicating a current one of the plurality of memory locations for storing a current one of the instructions;
a read pointer indicating one of the plurality of memory locations storing one of the instructions for outputting; and
a stall pointer indicating one of the plurality of memory locations storing a first one of the instructions not allocated by the instruction pipeline.

23. A method for processing instructions on a plurality of instruction threads in an instruction pipeline of a microprocessor, the method comprising the steps of:
selecting a first one of the plurality of instruction threads on which to issue at least one instruction;
issuing the at least one instruction on the first one of the plurality of instruction threads when a stall signal is not present on the first one of the plurality of instruction threads;
determining if a stall signal is present on a second one of the plurality of instruction threads;
switching to the second one of the plurality of instruction threads if the stall signal is not present on the second one of the plurality of instruction threads; and
issuing at least one instruction on the second one of the plurality of instruction threads.

24. The method of claim 23 further comprising the step of determining if the at least one instruction is available on the first one of the plurality of instruction threads.

25. The method of claim 23 further comprising the steps of:
monitoring the instruction pipeline to determine which one of the plurality of instruction threads has the most available resources; and
issuing at least one instruction on the one of the plurality of instruction threads having the most resources.

26. A method for processing instructions in an instruction pipeline of a microprocessor, the method comprising the steps of:
issuing instructions for processing by the instruction pipeline;
storing the issued instructions;
reissuing at least one of the stored instructions for further processing by the instruction pipeline after a stall occurs in the instruction pipeline.

27. The method of claim 26, wherein the at least one stored instruction had not been executed by the instruction pipeline prior to being reissued.
